(19) United States
(12) Patent Application Publication
(10) Pub. No.: US 2008/0163986 A1
(43) Pub. Date: Jul. 10, 2008

(54) Window shade detention member

(76) Inventor: Lin Ya Li, Shalu Township (TW)

Correspondence Address: BRUCE H. TROXELL, SUITE 1404, 5205 LEESBURG PIKE, FALLS CHURCH, VA, 22041, US

(21) Appl. No.: 11/650,586

(22) Filed: Jan. 8, 2007

(51) Int. Cl. E06B 9/322

(52) U.S. Cl. 160/175

(57) ABSTRACT

A window shade detention member universally installable on a sliding flute of a upper beam to provide positioning and chained movement for window shades includes a first action side and a second action side. The first action side is located on a transverse side of a detention member and has side boards extended upwards and inwards from two sides of a base board to form a first trough and a second trough that form a transverse clipping trough which clips side wings of the sliding flute of the upper beam. The first action side also provides bucking for the chained movement of the window shades. The second action side is located on a longitudinal side of the detention member and has a third trough and a fourth trough on two ends of the connection junctures of the base board and side boards to form a longitudinal clipping trough. The longitudinal clipping trough clips the side wings of the sliding flute of the upper beam. The first action side provides lengthwise constraint while the second action side provide bucking so that the window shade can be installed on different tracks and confined without skewing. Chained movement of retraction and extension of the window shade can be done smoothly. The elements are simplified and universally applicable. Installation of the window shade is more flexible and versatile.

### BACKGROUND OF THE INVENTION

1. Field of the Invention

The present invention relates to a window shade detention member and particularly to a detention member universally installable on a sliding flute of a upper beam to provide positioning and chained movement of a window shade, and universal and simplified structural elements and versatile installation of the window shade.

2. Description of the Prior Art

Many types of window shades are now available on the market. They are widely used in houses to enhance the appeal of interior design. To facilitate extension and retraction of the conventional window shades a complicated driving and chained moving mechanism often is required. To remedy this problem Applicant has proposed a technique disclosed in Taiwan patent publication No. M294283. However use of window shades is more versatile nowadays. Aside from installing on the same sliding flute and track, each window shade may also be installed on different tracks to create diagonal view and three dimensional visual effect (referring to FIG. 1). Thus installation of the window shade also is more versatile.

The conventional window shade 11, whether installed on the same track or different tracks, encounters a number of problems as follow:
1. The chained moving member 12 between the window shades 11 serves merely as a chained moving accessory. When installing on different tracks is required, the first anchor end 111 of the window shade 11 is installed on a first sliding flute 13, while the second anchor end 112 is installed on a second sliding flute 14, and a detention member 15 has to be installed to limit the length. The chained moving member 12 and the detention member 15 are not compatible or interchangeable. Hence the number of elements increases.
2. As the elements are not interchangeable, the procurement cost of the elements is higher. Management of a great number of elements is more complicated. Misplacement error frequently occurs on the installation site. This affects installation operation and efficiency.

### SUMMARY OF THE INVENTION

In view of the aforesaid problems, the present invention aims to provide a window shade detention member universally installable on a sliding flute of a upper beam to provide positioning and chained movement of window shades. It includes a first action side and a second action side. The first action side is located on the transverse side of the detention member and has side boards extended respectively upwards and inwards from two sides of a base board to form respectively a first trough and a second trough that form a transverse clipping trough to clip a side wing of the sliding flute of the upper beam. The first action side provides bucking for the chained movement of the window shade. The action second side is located on the longitudinal side of the detention member and has a third trough and a fourth trough on two ends of the connection junctures of the base board and the side boards to form a longitudinal clipping trough to clip another side wing of the sliding flute of the upper beam. The first action side provides lengthwise positioning, while the second action side provides bucking so that when the window shade is installed on different tracks it can be positioned as desired without skewing, and also may be chain-moved for retraction and extension. As a result positioning and chain-moving of the window shade is smoother, and the elements are simplified and can be used universally to make installation of the window shade more versatile.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of a conventional window shade with a chain-moving assembly.

FIG. 2 is a perspective view of the invention.

FIG. 3 is a transverse cross section of the invention.

FIG. 4 is a longitudinal cross section of the invention.

FIG. 5 is an exploded view of the invention.

FIG. 6 is a schematic view of a first embodiment of the invention in operating condition 1.

FIG. 7 is a schematic view of the first embodiment of the invention in operating condition 2.

FIG. 8 is a schematic view of the first embodiment of the invention in operating condition 3.

FIG. 9 is a schematic view of the first embodiment of the invention in operating condition 4.

FIG. 10 is an exploded view of a second embodiment of the invention.

FIG. 11 is a schematic view of the second embodiment of the invention in operating condition 1.

FIG. 12 is a schematic view of the second embodiment of the invention in operating condition 2.

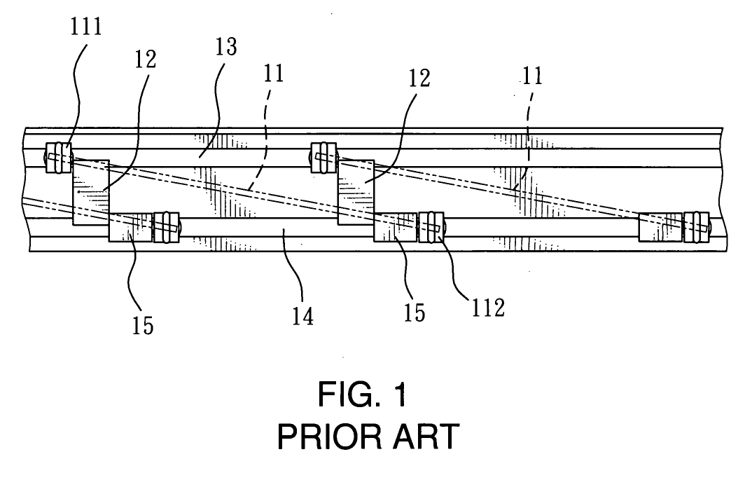

### DESCRIPTION OF THE PREFERRED EMBODIMENTS

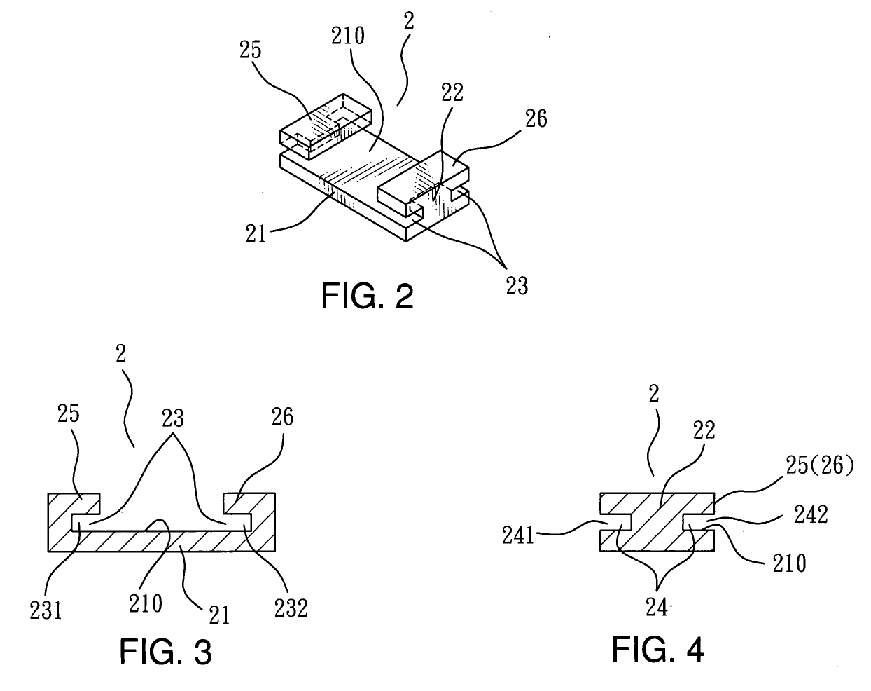

Referring to FIG. 2, the detention member 2 according to the invention includes a first action side 21 and a second action side 22 (also referring to FIGS. 2, 3 and 4).

The first action side 21 is located a transverse side of the detention member 2 (referring to FIG. 3) and has side boards 25 and 26 extended upwards and inwards from two sides of a base board 210 to form a first trough 231 and a second trough 232 between the side boards 25 and 26 and the base board 210 that correspond to each other and form a transverse clipping trough 23.

The second action side 22 is located on a longitudinal side of the detention member 2 (referring to FIG. 4).

In order to make a window shade universally installable on different tracks, the second action side 22 has a third trough 241 and a fourth trough 242 on two ends at the connection junctures of the base board 210 and the side boards 25 and 26 that correspond to each other and form a longitudinal clipping trough 24 (referring to FIG. 4). The longitudinal clipping trough 24 communicates with the transverse clipping trough 23.

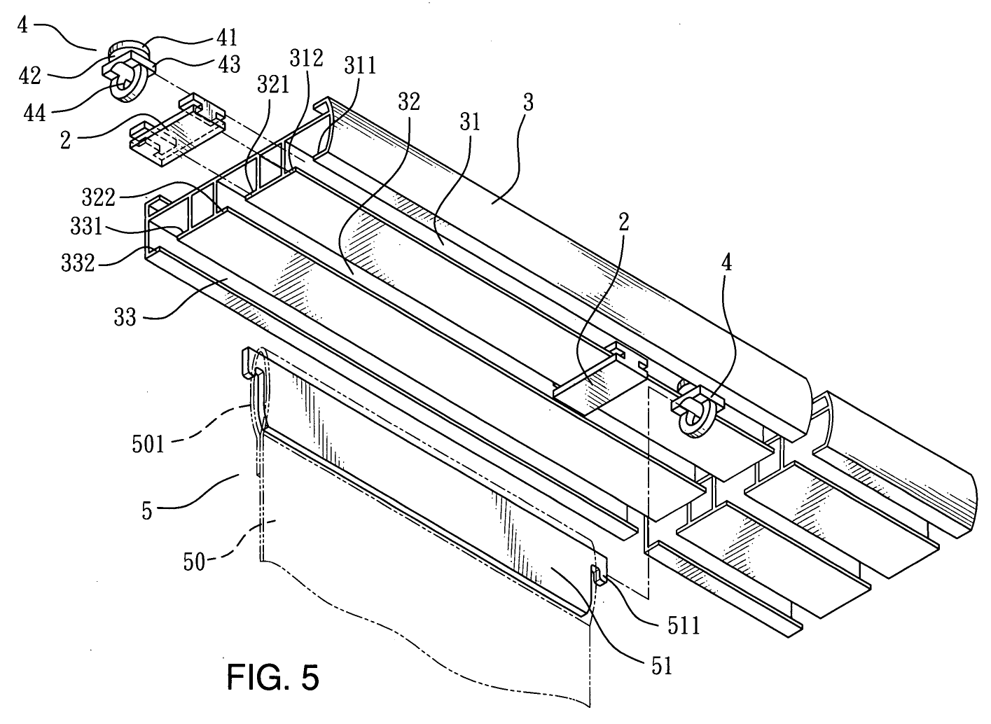

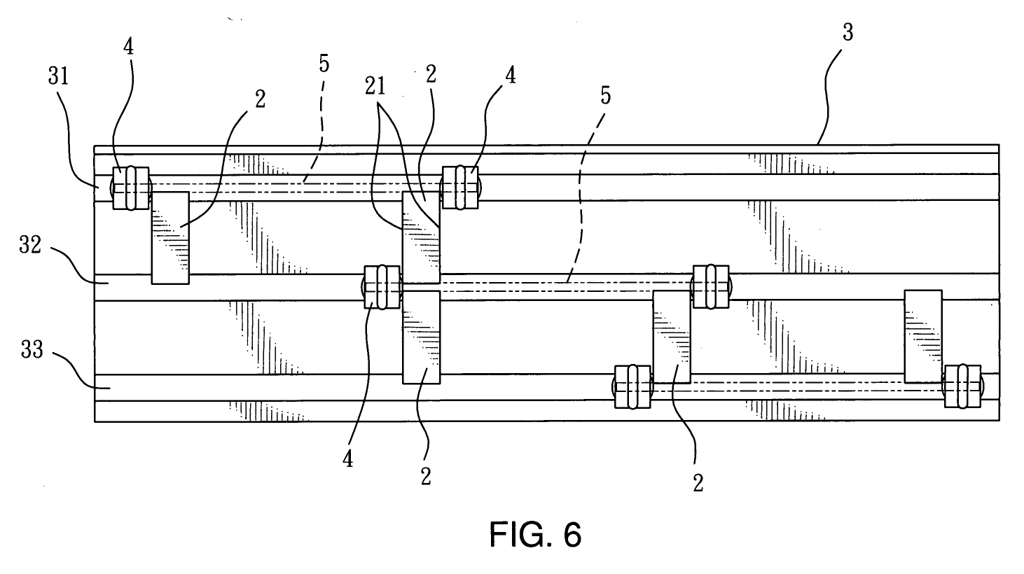

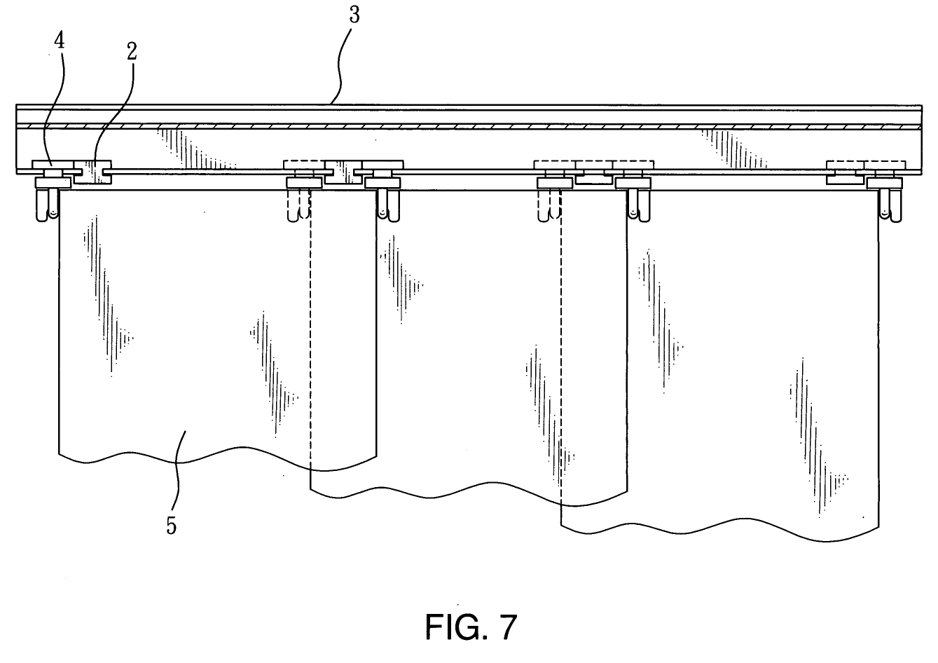

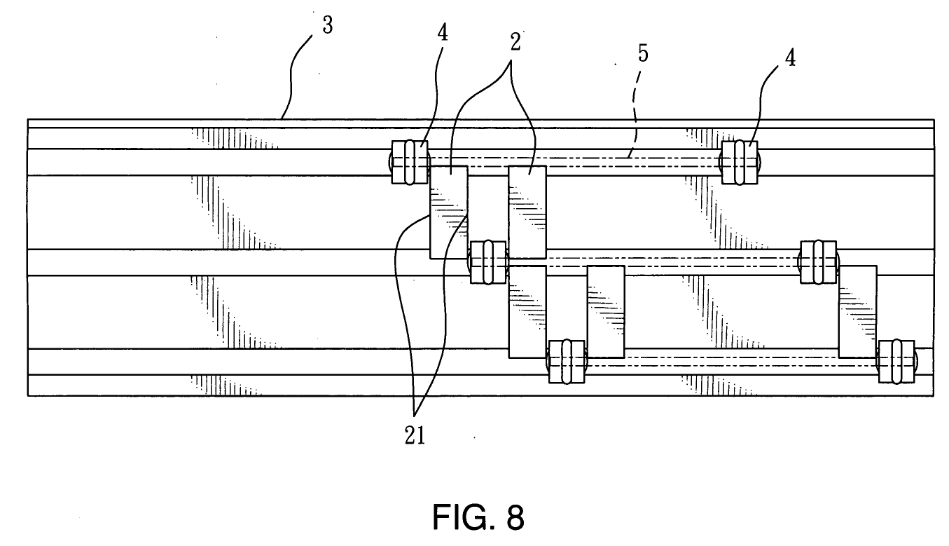

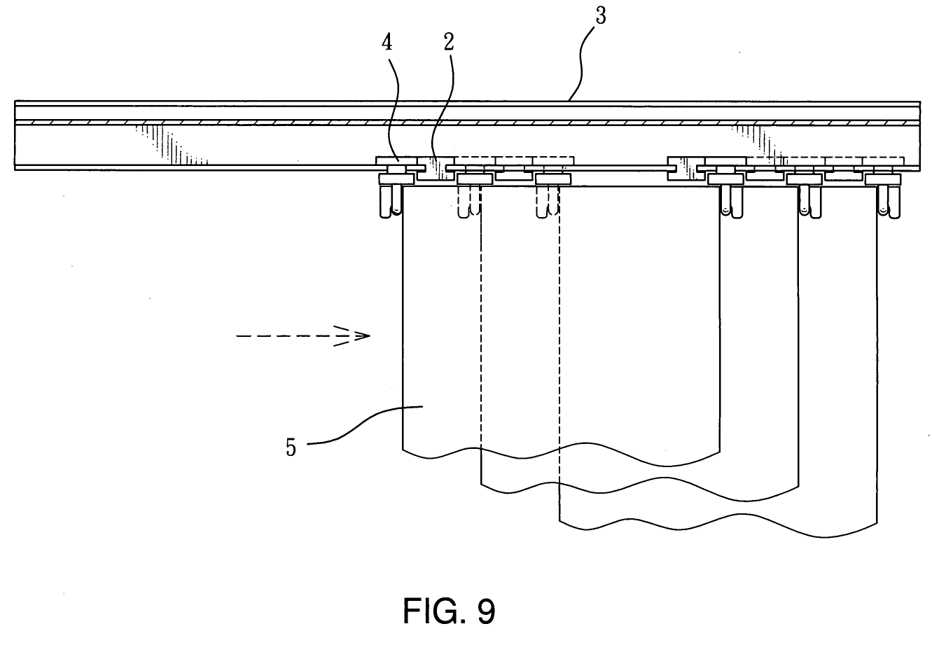

Refer to FIGS. 5 and 6 for an embodiment of a window shade 5 installing on a same sliding flute 31 (32, 33) of a upper beam 3. First, two sliding members 4 each has a upper flange 41 and a lower flange 43 to form a trough 42 therebetween are wedged in by sliding wings 311 and 312 (also 321, 322, 331 and 332) of the sliding flute 31 (also 32 and 33). A bracing blade 51 is provided and coupled on a coupling tube 501 of a slat 50 with two hanging hooks 511 of the bracing blade 51 exposed to be engaged with a hanging ring 44 of the sliding member 4 to finish installation of the window shade 5 on the same track. In this embodiment the detention member 2 is positioned transversely (referring to FIG. 6) between the two sliding flutes 31 and 32 (33). Namely the first trough 231 and the second trough 232 of the transverse clipping rough 23 clip respectively the side wings 312 and 321 (322, 331) of the two neighboring sliding flutes 31 and 32 (33). Hence when the window shade 5 is installed and extended, the first action side 21 rams the sliding member 4 of the neighboring window shade 5 to allow each window shade 5 to be moved and extended in a chained condition (referring to FIGS. 6 and 7). Similarly, retraction of the window shade also can be done as shown in FIGS. 8 and 9.

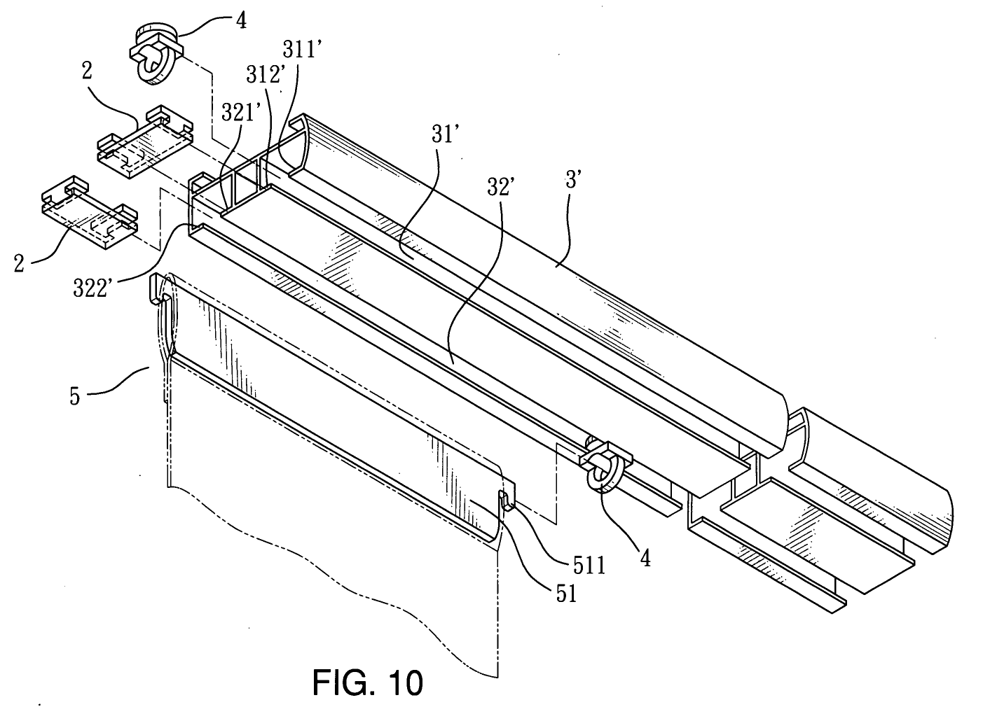

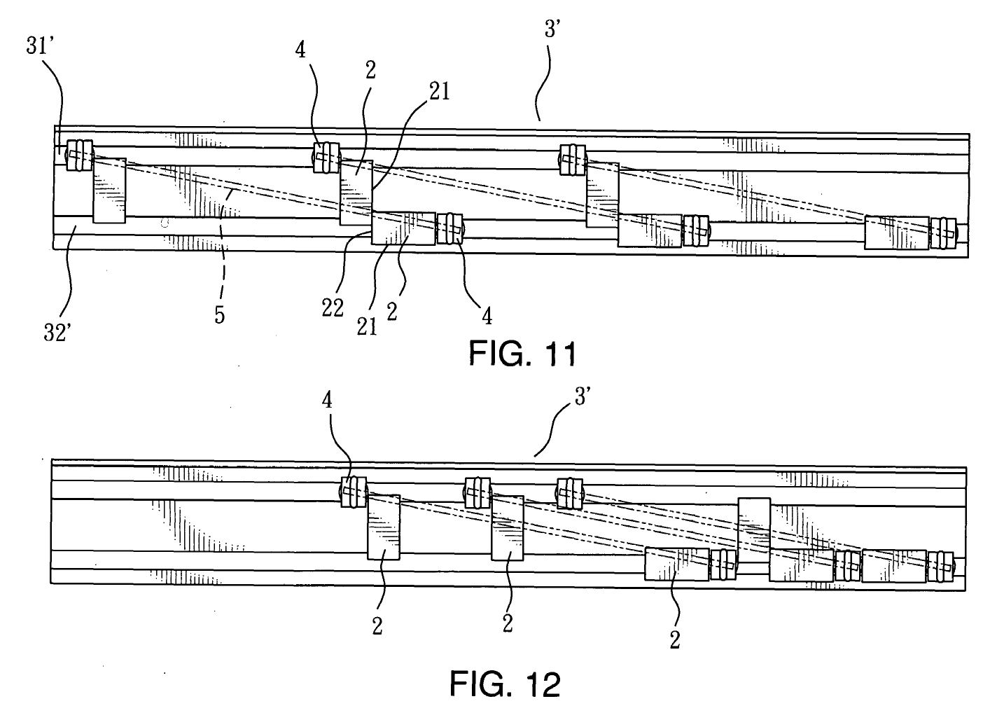

For universally installing the window shade on different tracks, with the third and fourth troughs 241 and 242 corresponding to each other on the second action side 22 to form the longitudinal clipping trough 24 communicating with the transverse clipping trough 23 as shown in FIGS. 10 and 11, the window shade 5 can be installed on different sliding flutes 31′ and 32′ of a upper beam 3′. Namely, the sliding members 4 are installed first on the different flutes 31′ and 32′. As the embodiment previously discussed, the slat 50 is coupled with the bracing blade 51 and hung on the hanging rings 44 through the hanging hooks 511. One detention member 2 is positioned transversely with the transverse clipping trough 23 clipping the side wings 312′ and 321′ of the neighboring sliding flutes 31′ and 32′ to chain-move the window shade 5. Another detention member 3 is positioned longitudinally with the longitudinal clipping trough 24 held in the sliding flute 32′ to harness the window shade 5. When the window shade 5 is pulled out and extended (referring to FIG. 11), the first action side 21 of the transverse detention member 2 provides bucking and a chained movement, while the first action side 21 of the longitudinal detention member 2 constrains lengthwise positioning. With the second action side 22 providing bucking function, the chained movement of the window shade 5 can be controlled without skewing. Similarly, retraction of the window shade also can be accomplished smoothly (referring to FIG. 12).

In short, the detention member of the invention can be universally installed on the sliding flute of the upper beam to provide positioning and chained movement of the window shade. It has simplified structural elements and is universally applicable, and makes installation of the window shade more flexible and versatile.

I claim:

1. A window shade detention member comprising a first action side and a second action side, wherein:
the first action side is located on a transverse side of a base board of a detention member and has two side boards formed by extending from two sides of the base board upwards and inwards to form a first trough and a second trough between the side boards and the base boards that become a transverse clipping trough;
the second action side is located on a longitudinal side of the base board.

2. The window shade detention member of claim 1, wherein the second action side has a third trough and a fourth trough formed on two ends of connecting junctures of the base board and the side boards.
